(19) United States
(12) Patent Application Publication
(10) Pub. No.: US 2011/0006672 A1
(43) Pub. Date: Jan. 13, 2011

(54) FLAT LIGHT SOURCE AND MANUFACTURING METHOD THEREOF

(76) Inventors: Sung-O Kim, Hsinchu County (TW); Chi-Neng Mo, Taoyuan County (TW); Po-Chuan Tsai, Taipei City (TW); Shang-Chih Wu, Taoyuan County (TW); Mei-Tsao Chiang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/538,156

(22) Filed: Aug. 9, 2009

(30) Foreign Application Priority Data
Jul. 9, 2009 (TW) 098123220

(51) Int. Cl. H01J 1/62; H01J 9/24

(52) U.S. Cl. 313/509; 445/23

(57) ABSTRACT

The present invention discloses a flat light source and a manufacturing method thereof. The flat light source includes a first substrate, a second substrate, and a first electrode, a first insulation layer, a first fluorescent layer that are in series disposed on the first substrate, and a second electrode, a second insulation layer, a second fluorescent layer that are in series disposed on the second substrate, and a gas discharge channel. The first electrode includes a conductive layer and a plurality of conical electrodes. Each conical electrode protrudes from the conductive layer and electrically connects to the conductive layer. The gas discharge channel is disposed between the first fluorescent layer and the second fluorescent layer where at least a discharge gas is filled in.

### BACKGROUND OF THE INVENTION

1. Field of the Invention

The present invention relates to a flat light source, and more particularly, to a flat light source with high brightness and high luminance efficiency.

2. Description of the Prior Art

In recent years, an LCD panel has become the prevailing display device because of its thin appearance, low power consumption and low radioactive contamination. As an LCD panel itself does not emit light, a backlight module is required to exhibit the display function.

The cold cathode fluorescent lamp (CCFL) is usually used as the light source in the backlight module because of its high brightness and mature technologies. The high brightness of CCFL comes from mercury (Hg) vapor which is filled into the lamp as a discharge gas. However, with the rise of environmental awareness in recent years, the use of mercury vapor has been limited to below 5 ppm in lots of countries, so development and use of mercury-free flat light source have become an important issue.

Please refer to FIG. 1, illustrating a schematic diagram of a conventional mercury-free flat light source. As shown in FIG. 1, the flat light source includes two transparent substrates 11, 13, two fluorescent layers 15, 17 disposed between the two transparent substrates 11, 13, a reflective layer 19 and a discharge channel 21. Xenon is filled into the discharge channel 21 as a discharge gas, in combination with neon as a buffer gas. The flat light source further includes a set of left electrodes 23a, 23b, and a set of right electrodes 25a, 25b. When applying an alternating current (AC) on the left electrodes 23a, 23b and the right electrodes 25a, 25b respectively, for example, applying a positive voltage on the left electrodes 23a, 23b and applying a negative voltage on the right electrodes 25a, 25b, a discharge path A is formed between two electrodes, making xenon in the discharge channel 21 dissociate to produce plasma. The excited atoms in the plasma will then release energy in the form of ultraviolet radiation and the ultraviolet will bomb into the fluorescent layer 15, 17 to emit visible light, so as to form a light source.

As the electrodes of the mercury-free flat light source are located in the right and left sides of the substrate, the longer discharge path (for example, the discharge path A) can therefore provide higher brightness and luminance efficiency. For example, under the gas mixture of 30% xenon/70% neon, 250 torr, supplied with 25 kHz AC voltage, the flat light source can be driven up to 14900 cd/m² of brightness and 35.9 lm/W of luminance efficiency. However, due to the increase in the discharge path, the drive voltage should be enhanced to 2.8 kV to achieve the above-mentioned brightness and luminance efficiency, which lays an operational risk of high-voltage driving. And when the discharge path is excessively long, most of plasma is generated beneath the region of the strongest electrical field (which is block B). Consequently, most of the generated visible light gathers in one place, causing a poor uniformity problem. In addition, the visible light is blocked by the non-transparent electrode 23b and electrode 25b, thereby reducing it output luminance.

As a result, a well-designed flat light source is still needed to solve aforesaid problems.

### SUMMARY OF THE INVENTION

The present invention discloses a flat light source, especially a flat light source with high brightness and high luminance efficiency.

According to the present invention, a flat light source is provided. The flat light source includes a first substrate, a second substrate, and a first electrode, a first insulation layer, a first fluorescent layer that are in series disposed on the first substrate, and a second electrode, a second insulation layer, a second fluorescent layer that are in series disposed on the second substrate, and a gas discharge channel. The first electrode includes a conductive layer and a plurality of conical electrodes. Each conical electrode protrudes from the conductive layer and electrically connects to the conductive layer. The gas discharge channel is disposed between the first fluorescent layer and the second fluorescent layer where at least a discharge gas is filled in.

According to the present invention, a method of manufacturing a flat light source is provided. The method includes: providing a first substrate, and then forming a first electrode on the first substrate, the first substrate including a conductive layer and a plurality of conical electrodes, wherein each conical electrode protrudes from the conductive layer and electrically connects to the conductive layer; then, forming a first insulation layer on the conical electrodes and the conductive layer and forming a first fluorescent layer between the first substrate and the first insulation layer; next, providing a second substrate and in series forming a second electrode, a second insulation layer and a second fluorescent layer on the second substrate; lastly, assembling the first substrate and the second substrate to form a gas discharge channel between the first substrate and the second substrate.

In the flat light source of the present invention, the generated plasma will not be confined to the conical electrode, but dispersed evenly in the gas discharge channel, so a uniform visible light is emitted. With the novel electrode designs in the present invention, the flat light source can obtain high brightness and luminance efficiency under low drive voltage, and can be widely used in a variety of display devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional mercury-free flat light source.

FIG. 2 illustrates a schematic diagram of the flat light source in the present invention.

FIG. 3 and FIG. 4 illustrate the 3D schematic diagrams of the flat light source in the present invention.

FIG. 5 and FIG. 6 illustrate the relationship diagrams of the brightness and the luminance efficiency vs. the drive voltage in the flat light source in the present invention.

FIG. 7 to FIG. 9 illustrate the schematic diagrams of fabricating the flat light source in the present invention.

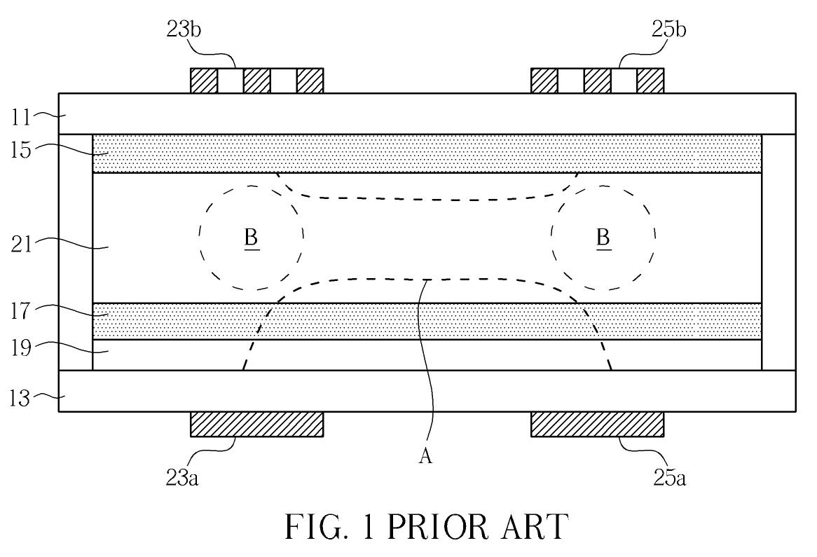

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”

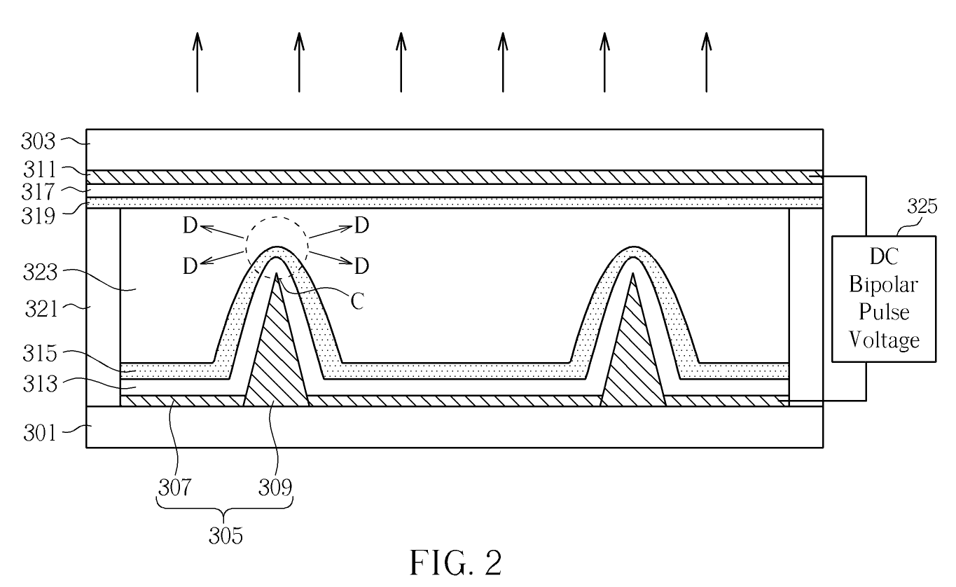

Please refer to FIG. 2, illustrating a schematic diagram of the flat light source in the present invention. As shown in FIG. 2, the flat light source in the present invention includes a first substrate 301, a first electrode 305, a second substrate 303 and a second electrode 311. The first substrate 301 and the second substrate 303 are disposed opposite to each other. The first substrate 301 and the second substrate 303 may include organic material or inorganic material, such as glasses, quartz, plastics, resin, acrylic or other suitable transparent material. The first electrode 305, disposed on the surface of the first substrate 301 facing the second substrate 303, includes a conductive layer 307 and a plurality of conical electrodes 309.

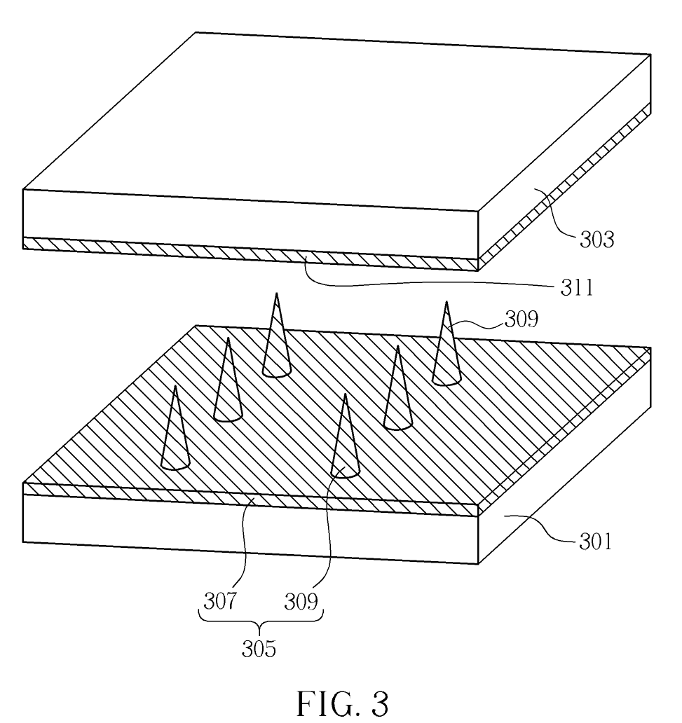

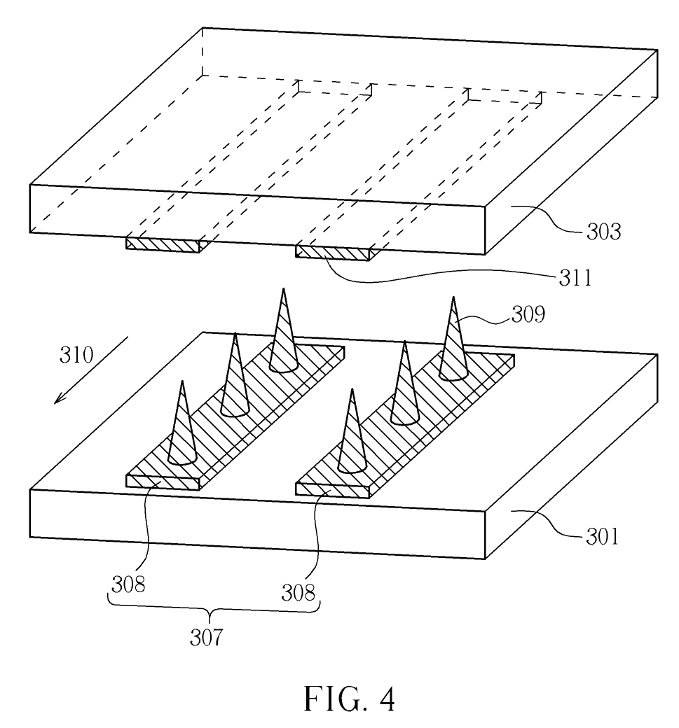

The conductive layer 307, which is disposed on the surface of the first substrate 301, may be a layer structure that fully covers the first substrate 301 or be a patterned structure. Please refer to FIG. 3 and FIG. 4, illustrating the 3D schematic diagrams of the flat light source in the present invention. For a better explanation, the figures only show the first substrate 301, the first electrode 305, the second substrate 303 and the second electrode 311. As shown in FIG. 3, the conductive layer 307 may include a single-layer or a multi-layer structure that fully covers the first substrate 301. Each conical electrode 309 protrudes from the conductive layer 307 and electrically connects to the conductive layer 307, rendering the conductive layer 307 and each conical electrode 309 form the first electrode 305.

In another embodiment of the present invention, the conductive layer 307 may include a patterned structure. As shown in FIG. 4, the conductive layer 307 includes a patterned layer structure that corresponds to the arrangement of each conical electrode 309. In FIG. 4, the conductive layer 307 includes a plurality of connection electrodes 308. The connection electrodes 308 are disposed in parallel to each other extending along a first direction 310. Each conical electrode 309 is protruding from each of the connection electrodes 308 and electrically connected to each of the connection electrodes 308.

It is worth noting that the second substrate 303 of the flat light source in the present invention is designed as a light emitting surface and the first substrate 301 is designed as a light reflecting surface. As a result, the material of the conductive layer 307, which is located on the light incident surface, should be selected from non-transparent conductive materials, more preferably, conductive materials that can be reflective, such as copper, aluminum, silver, etc. The material of the conical electrodes 309 may include copper, aluminum, silver or other metal conductive material that can be the same as the conductive layer 307, or different from the conductive layer 307, depending on varieties of circumstances. For instance, the conductive layer 307 may be made of silver, while the conical electrodes 309 may be made of aluminum. In the preferred embodiment of the present invention, the conical electrodes 309 are cone-shape, but without affecting the arrangement of other components, the conical electrodes 309 can be other three dimensional shape, such as a cylinder or other kinds of prism shape. The basic principle is that the conical electrodes 309 should protrude from the conductive layer 307 and the height of each conical electrode 309 protruding from the conductive layer 307 is preferably substantially between 2.5 mm and 3 mm, but not limited to.

Referring again to FIG. 2, the flat light source in the present invention further includes a first fluorescent layer 315 that fully covers the first substrate 301 and the first electrode 305 disposed thereon. The material of the first fluorescent layer 315 may include all kinds of organic fluorescent materials, inorganic fluorescent materials or mixture of organic and inorganic fluorescent materials. In addition, a first insulation layer 313 is disposed between the first electrode 305 and the first fluorescent layer 315 in order to protect and insulate the first electrode 305.

On the surface of the second substrate 303 that faces the first substrate 301, a second electrode 311, a second insulation layer 317 and a second fluorescent layer 319 are disposed in series. The second electrode 311 is disposed on the surface of the second substrate 303, and the second electrode 311 can be a layer structure that fully covers the second substrate 303 as shown in FIG. 3, or can be a patterned structure which is disposed over and corresponding to the first electrode 311 as shown in FIG. 4. The arrangement and pattern of the second electrode 311 should not be limited to the first electrode 307. For example, when the first electrode 311 is arranged as shown in FIG. 4, the second electrode 311 can also be the full layer structure as shown in FIG. 3. In addition, the second insulation layer 317 is disposed on the second electrode 311. It is noted that the second substrate 303 is designed as the light emitting surface of the flat light source, so a transparent material is used for the second electrode 311 and the second insulation layer 317. For example, the second electrode 311 can comprise indium tin oxide (ITO), indium zinc oxide (IZO), aluminum zinc oxide (AZO), gallium zinc oxide (GZO), magnesium indium oxide (MIO) or other transparent conductive materials. The second fluorescent layer 319 are disposed comprehensively on the second insulation layer 317 and the second substrate 303, and the material of the second fluorescent layer 319 may include all kinds of organic fluorescent materials, inorganic fluorescent materials or mixture of organic and inorganic fluorescent materials.

Please refer to FIG. 2. The flat light source of the present invention further includes a frame 321 disposed between the first substrate 301 and the second substrate 303, forming a confined gas discharge channel 323 between the first fluorescent layer 315 and the second fluorescent layer 319. The thickness of the frame 321 can be adjusted depending on the height of each conical electrode 309. It is preferred that the gap between the top of each conical electrode 309 and the second fluorescent layer 319 is substantially between 50 micro meters (μm) and 300 μm. At least a discharge gas is filled into the gas discharge channel 323, such as a variety of inert gas or other suitable gas. In the preferred embodiment of the present invention, xenon gas is filled into the gas discharge channel 323.

As shown in FIG. 2, when a direct current (DC) bipolar pulse voltage 325 is applied to the first electrode 305 and the second electrode 311, the flat light source is then turned on. The voltage formed between the electrodes 305, 311 will dissociate the xenon gas in the gas discharge channel 323 to form plasma and to emit a vacuum ultraviolet light, which will then bomb into the first fluorescent layer 315 and the second fluorescent layer 319 disposed upside and downside of the gas discharge channel 323, and a visible light is therefore produced. The visible light penetrates through the transparent second substrate 303 and the second electrode 311, and a flat light source is therefore formed.

Since the first electrode 305 and the second electrode 311 in the present invention are disposed respectively on the first substrate 301 and the second substrate 303, presenting a “one up and one down” electrode arrangement, a shorter and more even distribution of the electric field can be achieved. In addition, the conical electrodes 309 in the present invention are protruding from the conductive layer 307. According to the point discharge principle, the electric field between the two electrodes is concentrated on the tip region C above the conical electrodes 309, making more discharged plasma generated in the tip region C. Because the plasma is in a high energy state, in comparison with the lower voltage of the first electrode 305 and the second electrode 311, the plasma will, under the alternative operation of the DC bipolar pulse voltage 325, move to the first electrode 305 and the second electrode 311 in the lower voltage, that is, to the direction as the arrow D in FIG. 2 indicates. It is therefore that the plasma is not confined to the tip region C but dispersed evenly in the gas discharge channel 323, and a broader, more uniform flat light source is achieved.

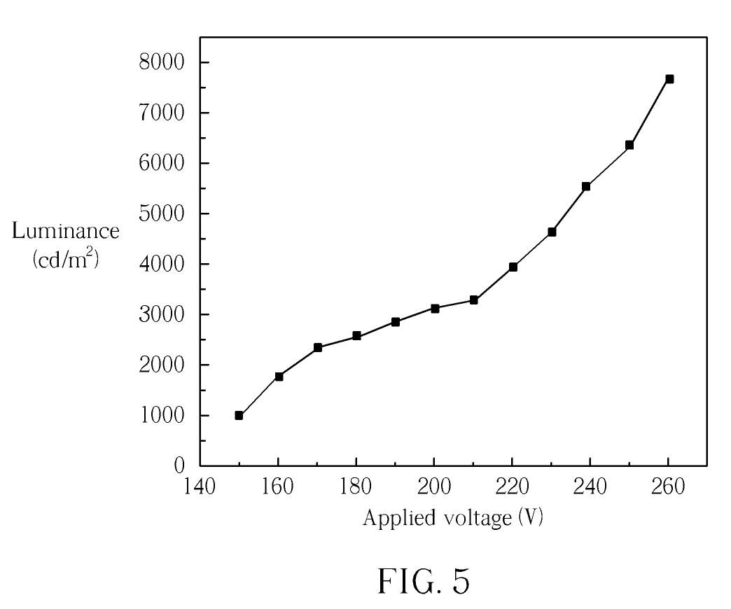

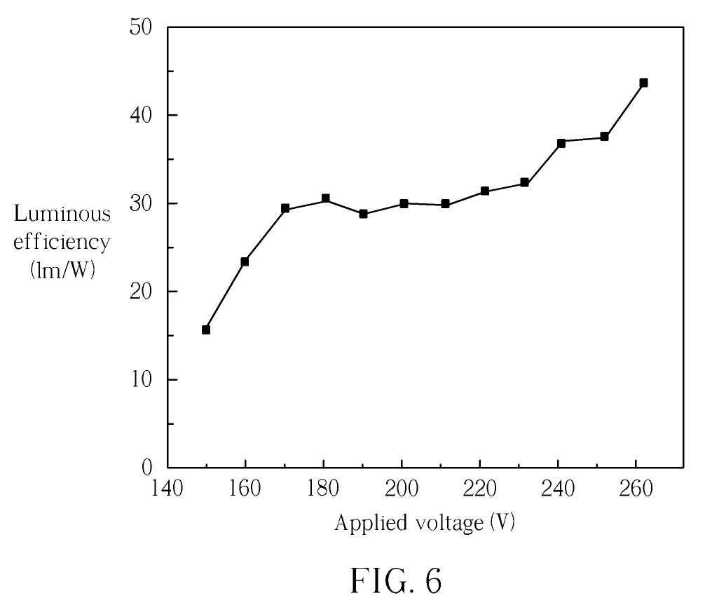

Please refer to FIG. 5 and FIG. 6, illustrating the relationship diagram of the brightness and the luminance efficiency vs. the drive voltage in the flat light source in the present invention. The drive voltage is from 150V to 260V. As shown in FIG. 5, the brightness of the flat light source increases when raising the voltage. In comparison with the 2.8 kV drive voltage in conventional art, the flat light source in the present invention can be turned on under 150V and reaching to 7800 cd/m² of brightness under 260V. As shown in FIG. 6, the luminance efficiency of the flat light source increases when raising the voltage as well, reaching to 44 lm/W of luminance efficiency under 260V. Accordingly, the flat light source in the present invention can be turned on under very low driving voltage and can achieve still high brightness and high luminance efficiency under low driving voltage. It can not only save electricity but is also applicable to all types of display devices.

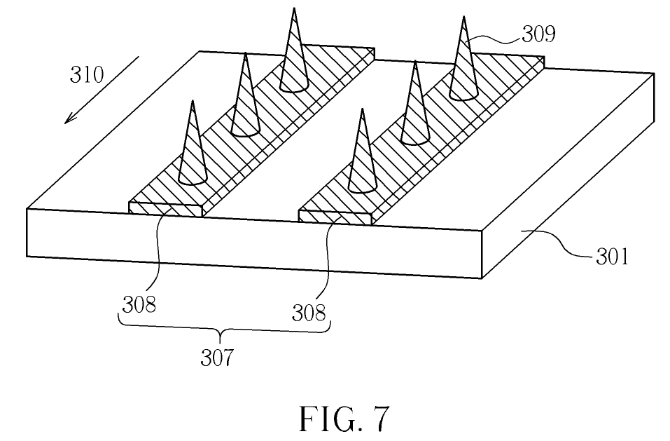

Please refer to FIG. 7 to FIG. 9, illustrating the schematic diagram of fabricating the flat light source in the present invention. As shown in FIG. 7, a first substrate 301 is provided, and then a conductive layer 307 is formed thereon. As described above, the conductive layer 307 can be a layer structure that fully covers the first substrate 301 or be a patterned structure. If the conductive layer 307 is a patterned layer, as shown in FIG. 7, it may include a plurality of connection electrodes 308. Each connection electrode 308 is disposed in parallel to each other and extends along a first direction 310. The connection electrodes 308 can be formed by a screen printing process, an ink jet printing process, a lithography process, etc. If the conductive layer 307 is a layer structure fully covers the first substrate 301, it can be formed directly by a deposition process.

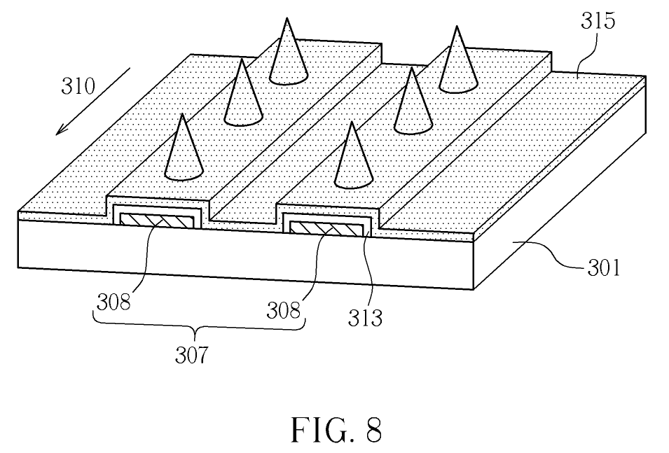

Next, a plurality of conical electrodes 309 is formed on the conductive layer 307 respectively. Each conical electrode 309 protrudes from the conductive layer 307 and electrically connects to the conductive layer 307, rendering the conductive layer 307 and each conical electrode 309 form the first electrode 305. Then, as shown in FIG. 8, a first insulation layer 313 is formed on the conductive layer 307 and the conical electrodes 309 by a screen printing process as well. Finally, a first fluorescent layer 315 is formed by a spraying process that sprays the fluorescent substance back and forth on the first insulation layer 313 and the first substrate 301, so that each component on the first substrate 301 is completed.

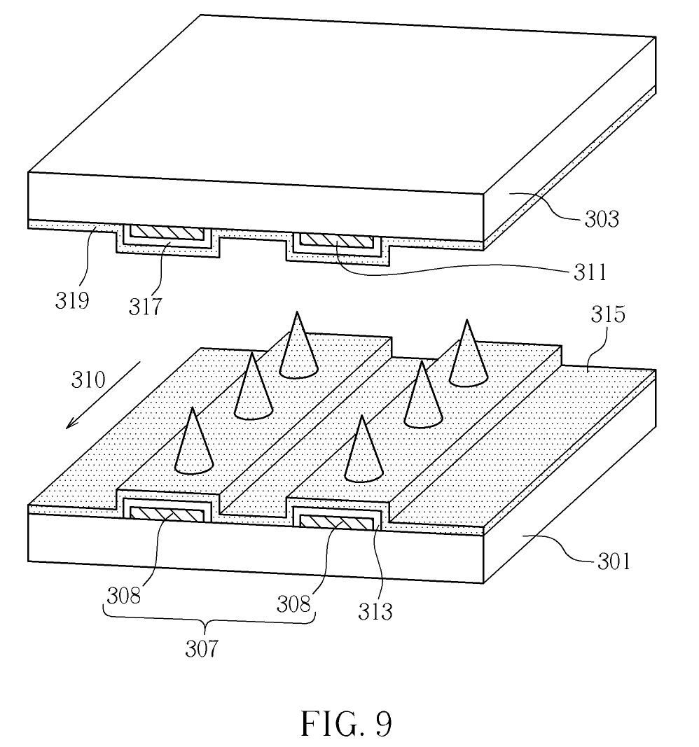

Referring to FIG. 9, a second substrate 303 is provided. Then a second electrode 311 is formed on the second substrate 303. If the second electrode 311 is a patterned layer, as shown in FIG. 9, it can be formed by a screen printing process, an inkjet printing process, a lithography process, etc. If the second electrode 311 is a layer structure fully covers the second substrate 303, it can be formed directly by a deposition process. Then a second insulation layer 317 is formed on the second electrode 311. A second fluorescent layer 319 is formed on the second insulation layer 317 and the second substrate 303 by a spraying process, so that each component on the second substrate 303 is completed.

Finally, the first substrate 301 and the second substrate 303 are assembled. For example, form a frame 321 between the first substrate 301 and the second substrate 303, making a confined gas discharge channel 323 formed between the first substrate 301 and the second substrate 303. Then a vacuuming process is providing to adjust the pressure of the gas discharge channel 323 to about 10⁻⁶ torr. A discharge gas such as xenon is filled into the gas discharge channel 323 and the flat light source in the present invention is thus completed.

In light of above, the present invention provides a flat light source structure that uses xenon as the discharge gas, which is in line with environmental protection. The flat light source further use the “one up and one down” electrode arrangement to produce stronger electric field, making the plasma not confined to the conical electrodes but dispersed evenly in the gas discharge channel and an uniform visible light source is therefore obtained. Because of the novel electrode design in the present invention, the flat light source can achieve high brightness and high luminance efficiency under low drive voltage and is applicable to all kinds of display device.

Those skilled in the art will readily observe that numerous modifications and alterations of the device and method may be made while retaining the teachings of the invention.

What is claimed is:

1. A flat light source, comprising:
a first substrate;
a second substrate disposed opposite to the first substrate;
a first electrode disposed on the surface of the first substrate facing the second substrate, the first electrode comprising a conductive layer and a plurality of conical electrodes, wherein each conical electrode protrudes from the conductive layer and electrically connects to the conductive layer;
a first fluorescent layer disposed on the first substrate and the first electrode;
a first insulation layer disposed between the first electrode and the first fluorescent layer;
a second fluorescent layer disposed between the second substrate and the first fluorescent layer;
a second electrode disposed between the second substrate and the second fluorescent layer;
a second insulation layer disposed between the second electrode and the second fluorescent layer; and
a gas discharge channel disposed between the first fluorescent layer and the second fluorescent layer, wherein at least a discharge gas is filled into the gas discharge channel.

2. The flat light source of claim 1, wherein the conductive layer comprises a plurality of connection electrodes disposed in parallel to each other, and the connection electrodes extend along a first direction.

3. The flat light source of claim 1, wherein a height of each conical electrode protruding from the conductive layer is substantially between 2.5 mm and 3 mm.

4. The flat light source of claim 1, wherein a gap between the top of each conical electrode and the second fluorescent layer is substantially between 50 μm to 300 μm.

5. The flat light source of claim 1, wherein the discharge gas comprises inert gas.

6. The flat light source of claim 5, wherein the inert gas comprises xenon.

7. The flat light source of claim 1, further comprising a frame disposed between the first substrate and the second substrate to make the gas discharge channel a confined space.

8. The flat light source of claim 1, wherein the first electrode and the second electrode comprise a direct current bipolar pulse voltage.

9. The flat light source of claim 1, wherein the second electrode comprises transparent conductive material.

10. The flat light source of claim 1, wherein the first electrode comprises reflective conductive material.

11. A method of fabricating a flat light source, comprising:
providing a first substrate;
forming a first electrode on the first substrate, the first electrode comprising a conductive layer and a plurality of conical electrodes, wherein each conical electrode protrudes from the conductive layer and electrically connects to the conductive layer;
forming a first insulation layer on the plurality of conical electrodes and the conductive layer;
forming a first fluorescent layer on the first substrate and the first insulation layer;
providing a second substrate and in series forming a second electrode, a second insulation layer and a second fluorescent layer on the second substrate; and
assembling the first substrate and the second substrate to form a gas discharge channel between the first substrate and the second substrate.

12. The method of claim 11, wherein the step of forming the first electrode comprises:
forming the conductive layer on the first substrate; and
forming the plurality of conical electrodes on the conductive layer.

13. The method of claim 12, wherein the step of forming the conductive layer comprises performing a screen printing process.

14. The method of claim 11, wherein the conductive layer comprises a plurality of connection electrodes disposed in parallel to each other, and the connection electrodes extend along a first direction.

15. The method of claim 11, wherein the step of assembling the first substrate and the second substrate comprises: forming a frame between the first substrate and the second substrate to make the gas discharge channel a confined space.

16. The method of claim 11, after the step of assembling the first substrate and the second substrate, further comprising:
providing a vacuuming process; and
filling a discharge gas into the gas discharge channel.

17. The method of claim 16, wherein the discharge gas comprises inert gas.

18. The method of claim 17, wherein the inert gas comprises xenon.

19. The method of claim 16, wherein the vacuuming process comprises adjusting the pressure of the gas discharge channel to about 10⁻⁶ torr.

20. The method of claim 11, wherein the step of forming the first insulation layer comprises performing a screen printing process.

21. The method of claim 11, wherein the step of forming the first fluorescent layer comprises performing a spraying process.

22. The method of claim 11, wherein the step of forming the second insulation layer comprises a screen printing process.

23. The method of claim 11, wherein the step of forming the second fluorescent layer comprises a spraying process.
